(19) United States
(12) Patent Application Publication
(10) Pub. No.: US 2011/0155105 A1
(43) Pub. Date: Jun. 30, 2011

(54) Control Unit of Fuel Injector

(75) Inventors: Yoshihiro SUKEGAWA, Hitachi (JP); Takuya Shiraishi, Hitachinaka (JP)

(73) Assignee: Hitachi Automotive Systems, Ltd., Hitachinaka-shi (JP)

(21) Appl. No.: 12/974,313

(22) Filed: Dec. 21, 2010

(30) Foreign Application Priority Data
Dec. 24, 2009 (JP) 2009-291699

(51) Int. Cl. F02D 41/04; F02M 69/14

(52) U.S. Cl. 123/478; 123/445

(57) ABSTRACT

An injection control unit of a fuel is provided, which prevents generation of a nozzle deposit of a fuel injector. In a control unit of a fuel injector capable of controlling a lift height that is a distance between a valve body and a valve seat, after start of fuel injection and before end of the fuel injection, after the lift height is controlled to a first height, a period in which the lift height is controlled to a second height which is lower than the first height is provided for a predetermined period. According to such a configuration, when the lift height of the valve body is lowered to the second height after the fuel is injected at the first height, a fuel velocity in the vicinity of an inner wall of an injection port is increased due to an inertial force of the fuel and reduction in an opening area. By a fuel flow at a high velocity, a contamination substance adhering to a wall surface is washed away.

### BACKGROUND OF THE INVENTION

1. Field of the Invention

The present invention relates to a control unit of a fuel injector of an internal combustion engine.

2. Background Art

It is known that the tip end of a fuel injector of an internal combustion engine is exposed to a combustion chamber, and a deposit such as carbon adheres to the area near the injection hole of the fuel injector including the valve body of the fuel injector. The adhering deposit decreases the substantial channel area of the injection hole, and influences the fuel injection characteristics of the fuel injector.

Conventionally, various kinds of arts of suppressing adherence of the deposits have been devised, and JP Patent Publication (Kokai) No. 2007-239686 discloses that the fuel injection rate is switched to the low injection rate range and the high injection rate range by changing the lift amount of the valve body, and the deposits accumulating in the vicinity of the injection hole are blown off by the fuel spray in the high injection rate range.

An object of the present invention is to suppress and prevent a deposit adhering to a fuel injector.

### SUMMARY OF THE INVENTION

In a control unit of a fuel injector capable of controlling a lift height that is a distance between a valve body and a valve seat, after start of fuel injection and before end of the fuel injection, after the lift height is controlled to a first height, a period in which the lift height is controlled to a second height which is lower than the first height is provided for a predetermined period (times).

According to such a configuration, when the lift height of the valve body is reduced to the second height after the fuel is injected at the first height of the lift height of the valve body, a fuel velocity in the vicinity of an inner wall of an injection port is increased due to the inertial force of the fuel and reduction in an opening area. By the fuel flow at a high velocity, the contamination substance adhering to the wall surface is washed away.

After sufficient development of the inertial force which is generated by injection of the fuel when the lift height is controlled to the first height, the valve body can be controlled to the second height. In order to take a sufficient period for controlling the lift height to the first height, the period in which the lift height is controlled to the second height can be set to be any timing in a latter half period in the case of dividing the fuel injection period into two. Further, the period for controlling the lift height to the second period is set at the period immediately before the end of the fuel injection period, the effect of the inertial force can be reliably obtained.

According to the present invention, carbon and non-volatile impurities which adhere to the nozzle wall surface are effectively cleaned and removed at each injection, and therefore, generation of deposits onto the nozzle can be prevented. As a result, change of the injection flow rate and spray form due to the nozzle deposits can be prevented, and the fuel efficiency, exhaust and output performance of the engine can be kept for a long period of time.

### BRIEF DESCRIPTION OF THE DRAWINGS

FIG. 1 shows an engine sectional view in one embodiment of the present invention.

FIG. 2 shows an engine perspective view in one embodiment of the present invention.

FIG. 3 shows a sectional view of a fuel injector in one embodiment of the present invention.

FIG. 4 (a) shows an enlarged view of a valve body side guide portion of the fuel injector in one embodiment of the present invention, and FIG. 4 (b) shows a sectional view of the valve body side guide portion.

FIG. 5 shows a configuration diagram, for driving and controlling the fuel injector in one embodiment of the present invention.

FIG. 6 shows relationship of an injector drive voltage and a lift amount in one embodiment of the present invention.

FIG. 7 shows an example of change with time of the drive voltage and the lift amount in one embodiment of the present invention.

FIG. 8 shows an injection hole sectional view at a valve closing time of the fuel injector in one embodiment of the present invention.

FIG. 9 shows an injection hole sectional view at a valve opening time of the fuel injector in one embodiment of the present invention.

FIG. 10 shows a perspective view of a spray form in one embodiment of the present invention.

FIG. 11 shows a fuel behavior at a time of high lift in one embodiment of the present invention.

FIG. 12 shows an example of deposit generation in an injection port.

FIG. 13 shows a flowchart of injection control in one embodiment of the present invention.

FIG. 14 shows a sequence of the drive voltage and lift in one embodiment of the present invention.

FIG. 15 shows fuel velocity change in one embodiment of the present invention.

FIG. 16 shows a fuel behavior in a nozzle at the time of high lift in one embodiment of the present invention.

FIG. 17 shows a fuel behavior in the nozzle at a time of low lift in one embodiment of the present invention.

FIG. 18 shows a fuel velocity vector in the nozzle at the time of low lift in one embodiment of the present invention.

FIG. 19 shows a CFD simulation result of the fuel velocity.

FIG. 20 shows the CFD simulation result of the fuel velocity.

FIG. 21 shows a valve lift sequence in one embodiment of the present invention.

FIG. 22 shows the valve lift sequence in one embodiment of the present invention.

FIG. 23 shows a valve lift sequence in one embodiment of the present invention.

FIG. 24 shows an injection hole sectional view at the valve closing time of the fuel injector in one embodiment of the present invention.

FIG. 25 shows a fuel behavior at a low lift valve opening time of the fuel injector in one embodiment of the present invention.

FIG. 26 shows a fuel behavior at a high lift valve opening time of the fuel injector in one embodiment of the present invention.

FIG. 27 shows the relationship of valve body lift and a spray angle of the fuel injector in one embodiment of the present invention.

FIG. 28 shows a flow of switch of a homogenous and a stratified combustion modes.

FIG. 29 shows a combustion mode map in one embodiment of the present invention.

FIG. 30 shows a schematic view of a fuel behavior in a combustion chamber in the homogenous combustion mode in one embodiment of the present invention.

FIG. 31 shows a schematic view of a fuel behavior in the combustion chamber in a stratified combustion mode in one embodiment of the present invention.

FIG. 32 shows a fuel behavior at a high lift valve opening time of the fuel injector in one embodiment in the present invention.

FIG. 33 shows a situation of generation of a nozzle deposit.

FIG. 34 shows a change in a fuel injection direction at a time of nozzle deposit generation.

FIG. 35 shows a flowchart of injection control in one embodiment of the present invention.

FIG. 36 shows a flowchart of injection control in one embodiment of the present invention.

FIG. 37 shows a sequence of the drive voltage and lift in one embodiment of the present invention.

FIG. 38 shows a sequence of a spray angle in one embodiment of the present invention.

FIG. 39 shows a change in a fuel velocity in one embodiment of the present invention.

FIG. 40 shows a sequence of the drive voltage and lift in one embodiment of the present invention.

FIG. 41 shows a sequence of the spray angle in one embodiment of the present invention.

FIG. 42 shows a sequence of the drive voltage and lift in one embodiment of the present invention.

FIG. 43 shows a flowchart of injection control in one embodiment of the present invention.

FIG. 44 shows a valve lift sequence in one embodiment of the present invention.

FIG. 45 shows a valve lift sequence in one embodiment of the present invention.

### DETAILED DESCRIPTION OF THE PREFERRED EMBODIMENTS

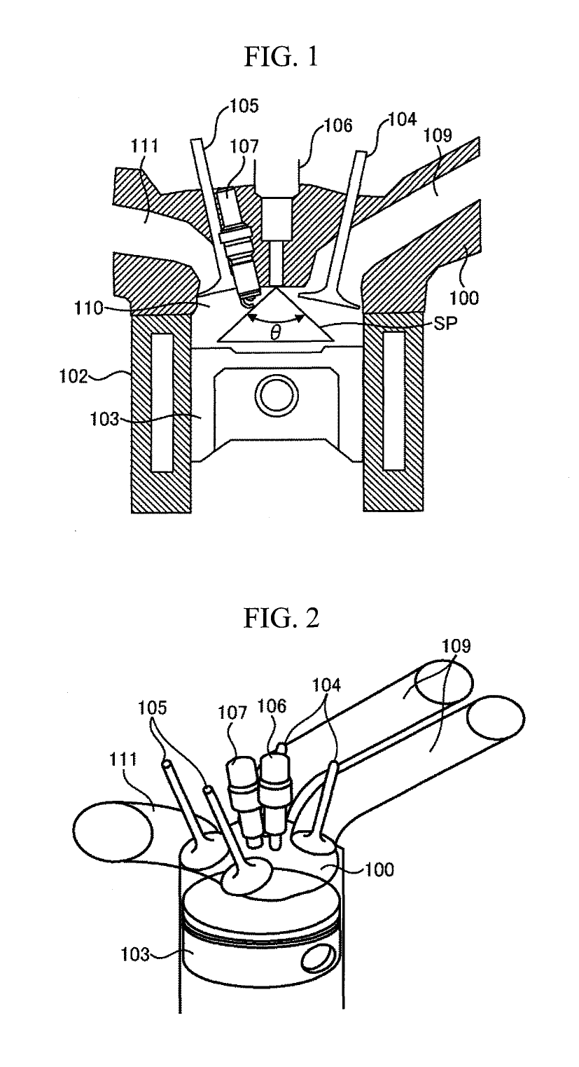

A configuration of a cylinder injection engine in a first embodiment is shown in FIGS. 1 and 2. FIG. 1 is a vertical sectional view of the cylinder injection engine in the present embodiment, and FIG. 2 is a perspective view of the cylinder injection engine in the present embodiment of the engine.

A combustion chamber 110 is formed by a cylinder head 100, a cylinder block 102, and a piston 103 inserted into the cylinder block 102. A fuel injector 106 is installed on a wall surface opposed to the piston 103, in the combustion chamber 110, and an ignition plug 107 is installed close to the fuel injector 106. An intake port 109 and an exhaust port 111 are respectively opened to the combustion chamber 110, and an intake valve 104 and an exhaust valve 105 which open and close the opening portions are provided.

The fuel injector 106 injects a fuel which is pressed to substantially 10 to 20 MPa by a fuel pump not illustrated in a spray form in a hollow cone shape from an injection port provided at a nozzle tip end of the fuel injector 106. The nozzle form, the fuel pressure and the like of the fuel injector 106 are set so that a Sauter mean diameter of spray SP to be injected becomes substantially 10 μm or less.

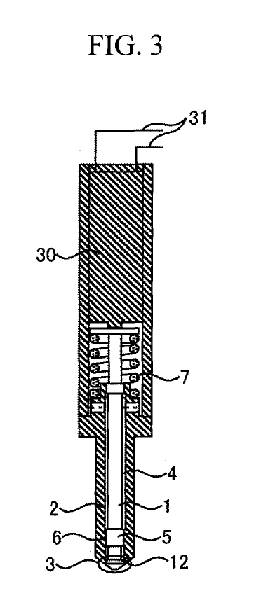

Next, a mode of the fuel injector 106 in the present embodiment will be described by using FIGS. 3 to 12.

FIG. 3 is a sectional view showing an internal structure of the fuel injector. A nozzle 2 is cylindrical, and a valve body 1 is inserted in the nozzle 2, and the valve body 1 has the structure which moves in the axial direction with respect to the nozzle 2. The valve body 1 and the nozzle 2 are provided with a valve body side guide portion 5 for guiding movement in the axial direction of the valve body 1 and a nozzle side guide portion 6. The valve body 1 is thinner than the inside diameter of the nozzle 2, and a gap between the valve body 1 and the nozzle 2 forms a fuel channel 4.

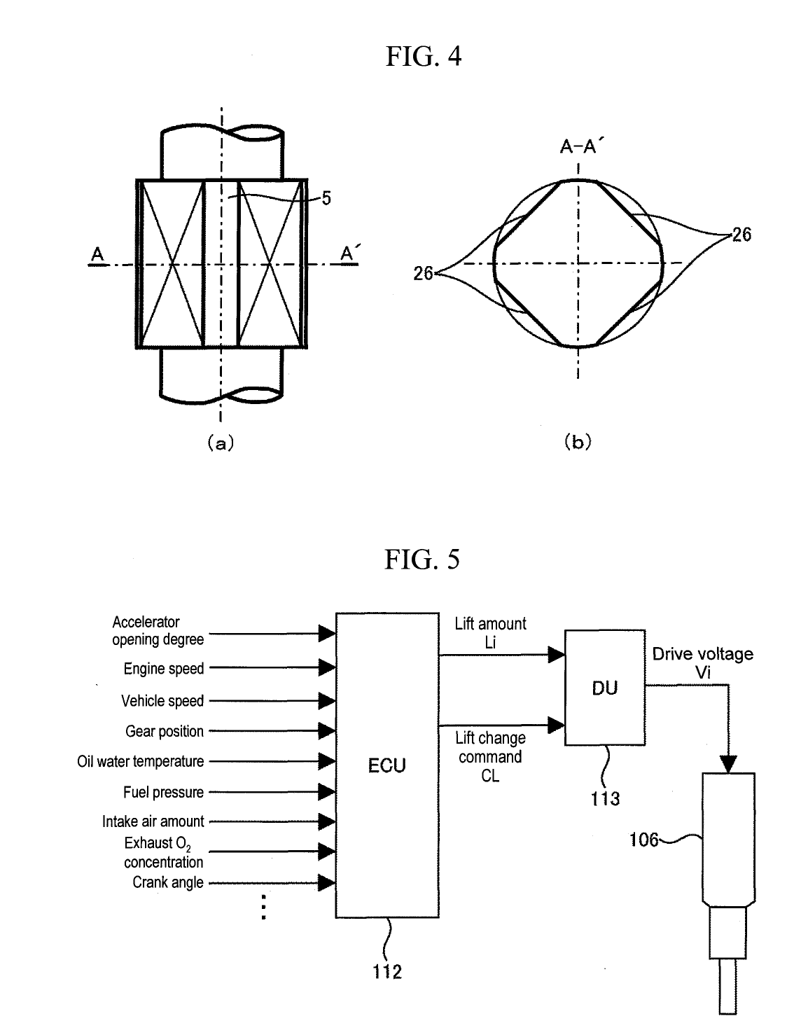

FIG. 4 (a) shows an enlarged view of the valve body side guide portion, and FIG. 4 (b) shows a section of the valve body side guide portion. Square cut 26 is applied to the valve body side guide portion 5, and a gap exists between a portion of the square cut 26 and the nozzle side guide portion 6, and therefore, the structure is provided, which does not hinder the flow of the fuel flowing in the fuel channel 4.

The fuel passes through the fuel channel 4 and is fed to an injection hole 3. The valve body 1 is usually pulled by a valve opening spring 7, and therefore, the valve body 1 and the nozzle 2 are in contact with each other in a contraction portion 12. Therefore, the fuel is not injected from the injection hole 3. At a side of the valve body 1, which is axially opposite from the injection hole 3, a piezoelectric element 30 for controlling a lift amount (a lift height) in the axial direction of the valve body 1 is provided. A lead wire 31 is led outside the injector from a piezoelectric unit. When a voltage is applied to the lead wire 31, the piezoelectric element 30 extends in the axial direction, and the valve body 1 is pushed down to generate a gap in the contraction portion 12, whereby the fuel is injected from the injection hole 3.

FIG. 5 shows a configuration diagram for driving and controlling the fuel injector. In FIG. 5, reference numeral 113 designates a driver unit of the fuel injector, and reference numeral 112 designates an engine control unit (ECU). The ECU 112 sends a lift amount (a lift height) Li of the injector 106 and a lift change command CL to the driver unit 113. When the driver unit 113 receives the lift command CL from the ECU, the driver unit 113 applies a predetermined drive voltage Vi to the injector 106 so that the lift amount of the fuel injector 106 becomes Li which is instructed by the ECU.

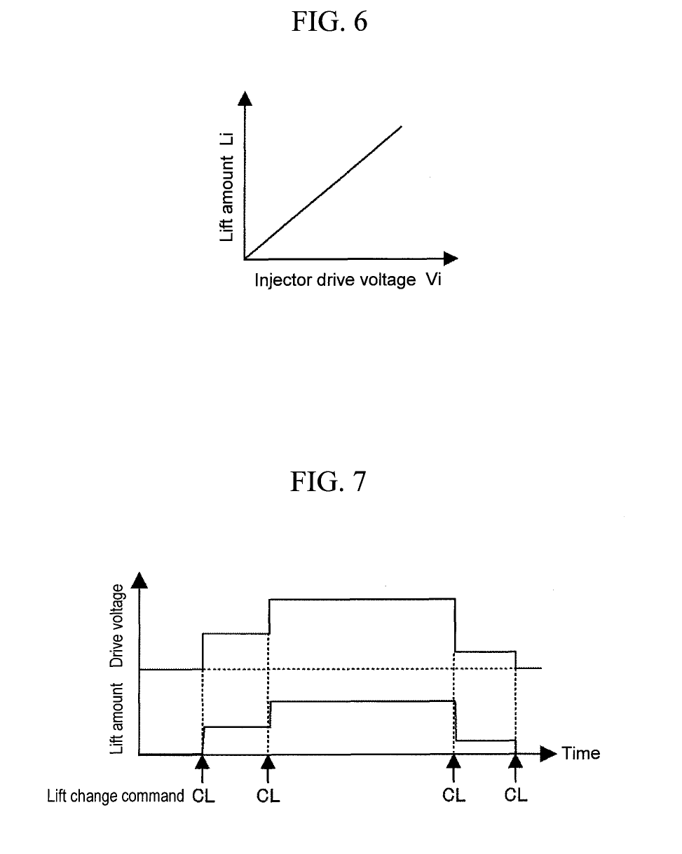

FIG. 6 shows the relationship of the fuel injector drive voltage Vi and the injector lift amount Li. The injector lift amount Li is proportional to the drive voltage Vi. With use of the relationship, the drive voltage Vi with respect to the required lift amount Li is obtained in the driver unit 113, and a predetermined voltage is applied to the injector 106.

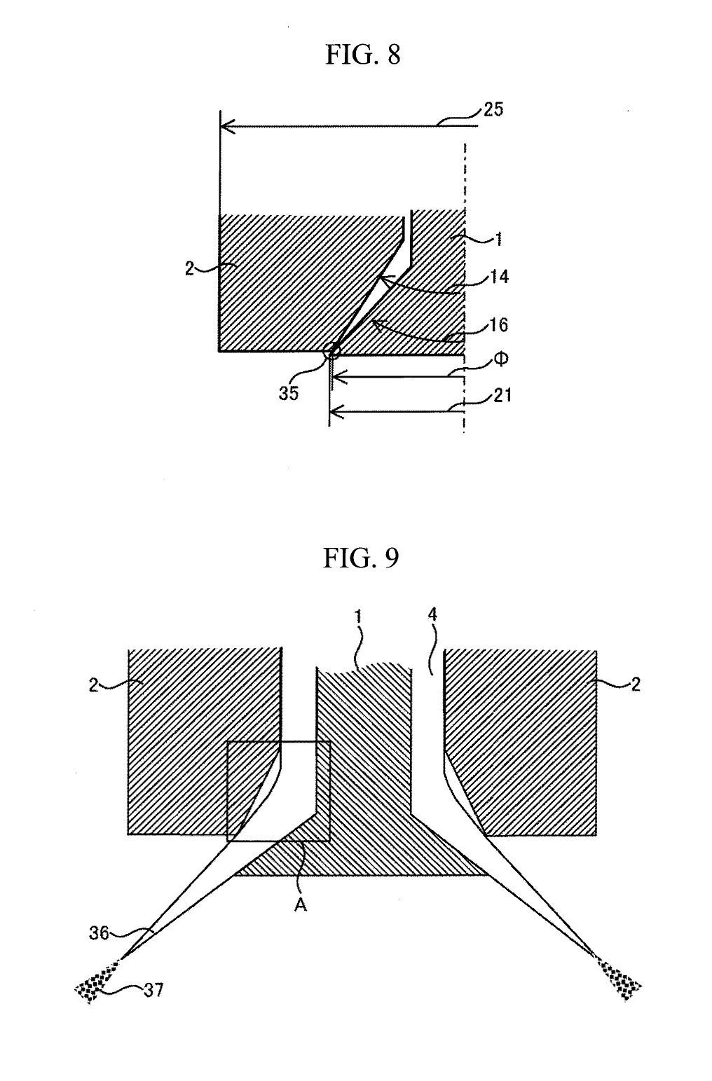

FIG. 7 shows an example of change with time of the drive voltage and the lift amount. When the lift command CL is sent to the driver unit from the ECU, the driver unit immediately applies the drive voltage corresponding to the required lift amount to the fuel injector. The driver unit keeps the drive voltage until the next lift command CL is sent to it. The response of the piezoelectric unit is at an extremely high speed, and therefore, when the drive voltage is changed, the lift amount of the fuel injector immediately changes to the height corresponding to the drive voltage. Like this, the relation of substantial similarity is obtained in the time profiles of the drive voltage waveform and the lift amount of the fuel injector.

Next, the structure of the injection hole 3 will be described by using FIG. 8. FIG. 8 is a sectional view showing an internal structure of the injection hole 3 at a valve opening period. In the injection hole 3, the nozzle 2 and the valve body 1 respectively have tapers in the shapes of substantially conical surfaces. A taper angle 16 (angle formed by a taper surface and a taper surface at an opposite side from the taper surface) of the valve body 1 is, for example, 90°, and a taper angle 14 of the nozzle 2 is, for example, 60°. More specifically, the taper angle 16 of the valve body 1 is large as compared with the taper angle 14 of the nozzle. Further, a lower end portion diameter 21 of the valve body 1 is large as compared with a diameter (φ) of the nozzle opening portion.

When the valve body 1 is pushed upward, the valve body 1 and the nozzle 2 are brought into contact with each other on a circumferential surface 35, and the fuel in the injection port and the outside are shut out. In this manner, the fuel is linearly sealed by the circumferential surface 35 with the valve body closed, and thereby, high hermeticity can be held against working tolerance and thermal deformation of the valve body and the nozzle.

Next, the fuel behavior in the injection port at the valve opening time of the valve body will be described with use of FIG. 9. FIG. 9 is a sectional view showing the internal structure of the injection hole 3 at the valve opening time.

When the valve body 1 is pushed downward, a gap occurs between the valve body 1 and the nozzle 2, and the high-pressure fuel in the fuel channel 4 spouts outside as a fuel liquid film 36. The fuel flows along the taper surfaces of the valve body and the nozzle, and therefore, the fuel liquid film which is injected is in a hollow cone shape. The thickness of the liquid film 36 becomes smaller as it is away from the injection port, and the tip end of it splits, whereby microscopic droplets 37 are generated.

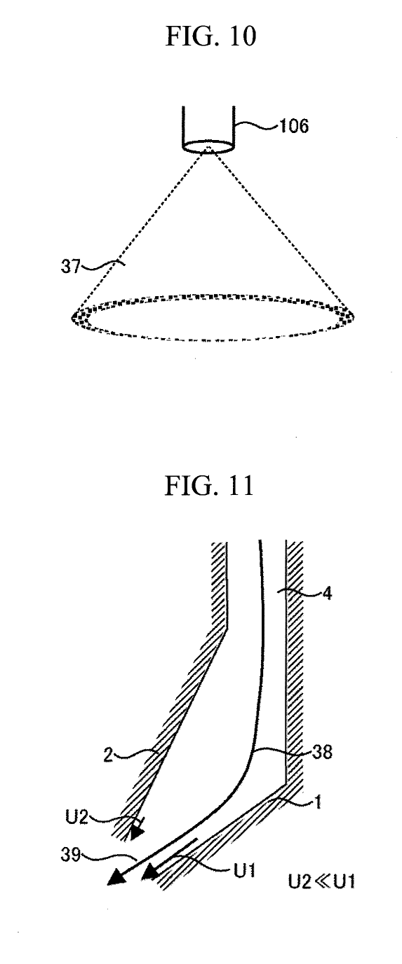

FIG. 10 is a perspective view of a spray form which is generated. As shown in FIG. 10, in the fuel injector 106 in the present embodiment, spray in a hollow cone shape is formed.

Next, with use of FIG. 11, the flow of the fuel in the injection port will be described in more detail. FIG. 11 is a view of enlargement of a portion of A shown in FIG. 9. In FIG. 11, reference numeral 38 shows the flow of the fuel in the injection port. The fuel descends in the axial direction inside the fuel channel 4, has the flow direction curved in the radius direction by the tapers of the valve body 1 and the injection port 2, and flows outside from the opening portion 39. Since the velocity of the fuel flowing in the fuel channel 4 becomes several tens m/s or more, and high, and therefore, a strong inertial force works on the fuel downward in the axial direction. Therefore, in the taper portion, the fuel is strongly pressed against the valve body 1 side. Meanwhile, by the same inertial force, the fuel is separated from the wall surface of the nozzle 2 in the taper portion. As a result, in the opening portion 39, a fuel velocity U2 in the vicinity of the surface of the nozzle 2 becomes significantly low as compared with a fuel velocity U1 in the vicinity of the surface of the valve body 1.

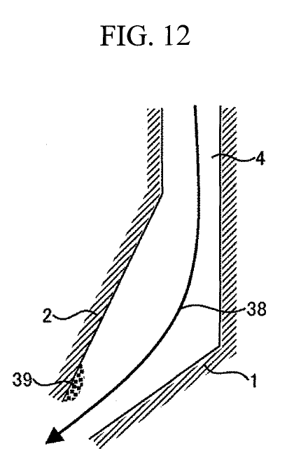

Meanwhile, carbon which is generated by combustion and non-volatile impurities such as gum substances, which are contained in the fuel, adhere onto the wall surface in the injection port. These carbon and impurities are washed away from the wall surface by a shearing force of the fuel flow at each injection and do not accumulate, if there is a high-speed fuel flow in the vicinity of the wall surface. However, when the fuel velocity in the vicinity of the wall surface is low, the shearing force of the fuel flow is weak, and therefore, the carbon and impurities adhering to the wall surface are not sufficiently washed away, and accumulate on the wall surface each time fuel injection and combustion are repeated. Therefore, as shown in FIG. 12, the opening portion 39 is formed on the surface of the nozzle 2 where the fuel flow is slow. The opening 39 causes reduction in the injection flow rate and change in the spray shape of the fuel, and becomes the cause of worsening of the exhaust emission and reduction in output of the engine.

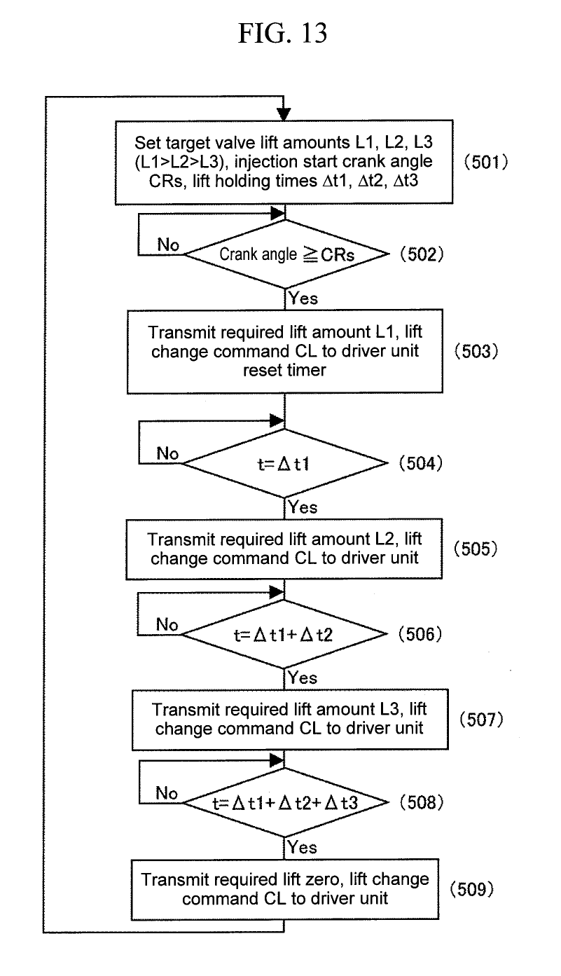

Next, with use of FIG. 13, the control unit of fuel injection in the first embodiment of the present invention will be described.

FIG. 13 shows a processing flow in the ECU at the period of fuel injection in the present embodiment. In processing 501, target lift amounts L1, L2 and L3 of the fuel injector, and holding periods Δt1, Δt2 and Δt3 of the respective lift amounts, and an injection start crank angle CRs are set. Here, L1, L2 and L3, Δt1, Δt2 and Δt3 and CRs are set so that proper air-fuel ratio and injection timing which are set in advance can be obtained based on various kinds of information such as the accelerator opening degree, the engine speed, the vehicle speed, the gear position, the oil water temperature or water temperature and the fuel pressure which are input in the ECU.

Further, as for the relation of magnitude of the lift amounts L1, L2 and L3, the respective lift amounts are determined so that L1>L2>L3 is satisfied. For example, the lift amount L2 is set to be about ½ to ⅕ of the lift amount L1. Alternatively, the lift amount L2 does not necessarily have to be changed in accordance with the magnitude of the lift amount L1, and if it is previously known that the lift amount L1 is always set at 30 μm or more, for example, the lift amount L2 may be fixed to a value (for example, 10 μm) smaller than this. When the fuel injector is kept in the state of the lift amount L2, the fuel is set to be injected by a constant amount (for example, about ½ to ⅕ with respect to the injection amount per unit time when the lift amount is set at L1) or more.

Further, the holding period Δt2 of the lift amount L2 is desirably shorter than the holding period Δt1 of the lift amount L1. Further, the holding period Δt2 may be fixed to a short period (for example, 0.3 ms) in advance.

Meanwhile, the lift amount L3 is set at a very small value so that the unit time injection amount when the lift amount is kept at L3 becomes about 1/100 or less with respect to the injection amount per unit period when the lift amount is set at L1, for example. Further, Δt3 is set at a short period, that is, about 1/10 or less of Δt1, for example, about 0.2 ms. More specifically, a fuel amount Mf1 which is injected in Δt3 with the lift amount L3 is very small and about 1/1000 or less with respect to the fuel amount Mf1 which is injected in Δt1 with the lift amount L1, and the fuel injection amount in Δt3 can be substantially ignored with respect to combustion.

For example, when the required load of the engine is determined as an intermediate or a high load in the state in which the engine is warmed up, based on various kinds of information input in the ECU, the homogenous combustion mode is selected, and a required injection amount Mf is obtained from the intake air amount so that the air fuel ratio in the cylinder becomes a theoretical air fuel ratio (A/F=14.7). The required rift amounts L1 and L2 and the lift holding periods Δt1 and Δt2 are determined so that Mf1+Mf2 which is the total of the fuel amount Mf1 injected in Δt1 with the lift amount L1 and a fuel amount Mf2 injected in Δt2 with the lift amount L2 becomes the required injection amount Mf. Further, the injection start crank angle CRs is set at, for example, 90° after an intake upper dead center so that fuel injection is performed within the intake stroke.

For example, when the required load of the engine is determined as a low load in the state in which the engine is warmed up based on various kinds of information input in the ECU, the stratified combustion mode is selected, and the required injection amount Mf is obtained from the intake air amount so that the air fuel ratio in the cylinder becomes higher (for example, A/F=90) than the theoretical air fuel ratio. The required lift amounts L1 and L2 and the lift holding periods Δt1 and Δt2 are determined so that Mf1+Mf2 which is the total of the fuel amount Mf1 injected in Δt1 with the lift amount L1 and the fuel amount Mf2 injected in Δt2 with the lift amount L2 becomes the required injection amount Mf. Further, the injection start crank angle CRs is set at, for example, 330° after the intake upper dead center so that fuel injection is performed in the latter period of the compression stroke.

In processing 502, the injector waits until the present crank angle reaches the injection start crank angle CRs.

When the crank angle reaches the injection start crank angle CRs, in processing 503, the required lift amount L1 and the lift change command CL are transmitted to the driver unit, and the timer is reset (t=0). Thereby, the elapsed time (elapsed period) from the injection start is shown in the timer.

In processing 504, an elapsed time t and the lift holding period Δt1 are compared, and when the elapsed time becomes Δt1, the flow proceeds to processing 505.

In processing 505, the required lift amount L2 and the change command CL are transmitted to the driver unit.

In processing 506, the elapsed time t and the lift holding period Δt1+Δt2 are compared, and when the elapsed time reaches Δt1+Δt2, the flow proceeds to processing 507.

In processing 507, the required lift amount L3 and the lift change command CL are transmitted to the driver unit.

In processing 508, the elapsed time t and the lift holding period Δt1+Δt2+Δt3 are compared, and when the elapsed time reaches Δt1+Δt2+Δt3, the flow proceeds to processing 509.

In processing 509, the required lift amount L=0 and the lift change command CL are transmitted to the driver unit.

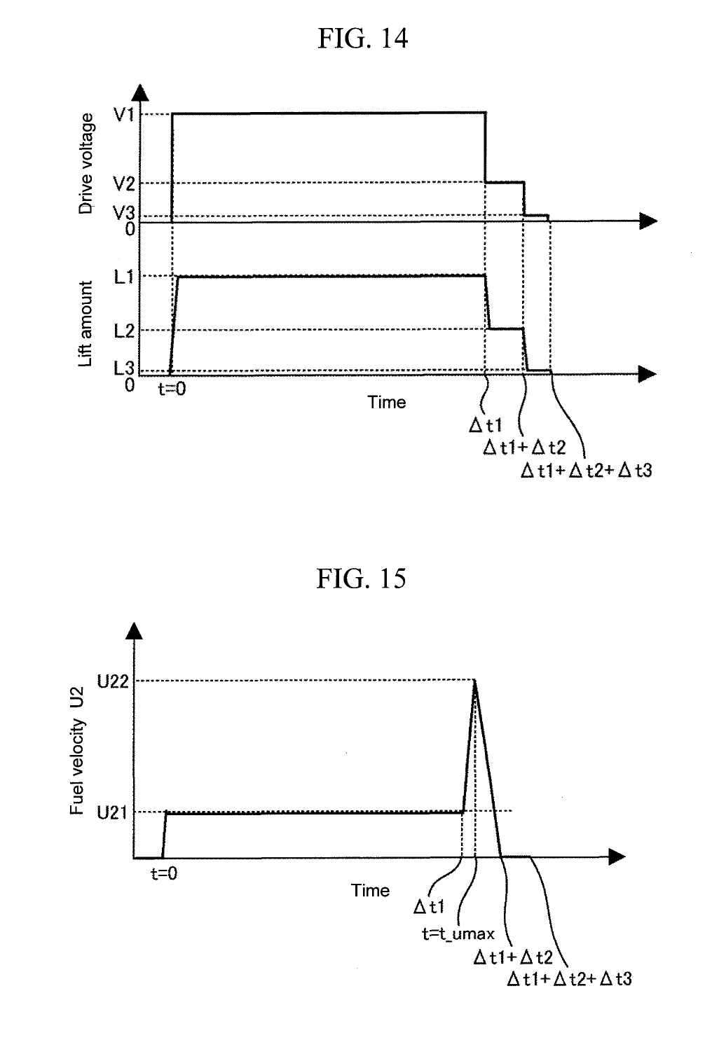

According to the processing flow at the fuel injection period shown above, the voltage applied to the fuel injector and the lift amount are as shown in FIG. 14.

At time t=0, the drive voltage V1 corresponding to the lift amount L1 is applied to the fuel injector from the driver unit, the lift amount of the injector becomes L1 from zero (valve closed state), and fuel injection is started.

After the lift amount L1 is kept in the time period from the time t=0 to Δt1, the drive voltage V2 corresponding to the lift amount L2 is applied to the fuel injector from the driver unit at the time t=Δt1, and the lift amount of the injector is changed from L1 to L2 which is a smaller lift amount.

After the lift amount L3 is kept in a time period from the time (period) t=Δt1+Δt2 to Δt1+Δt2+Δt3, the drive voltage which is applied to the fuel injector from the driver unit becomes zero at the time (period) t=Δt1+Δt2+Δt3, and the injector is closed, whereby fuel injection is finished.

Here, the reason why the valve opening operation is performed after the very small lift amount (L3) is kept from t=Δt1+Δt2 to t=Δt1+Δt2+Δt3 is to suppress bouncing and tapping sound of the valve body at the valve closing time. More specifically, if the valve is abruptly closed from the high lift amount, the valve body collides against the nozzle wall surface at a high speed, and therefore, there is the fear of occurrence of bouncing and occurrence of large tapping sound to the valve body. By way of a very low lift state just before valve closing, the impact at the period of closing the valve body is softened, and bouncing and tapping sound can be reduced. However, in the very low lift state, injection speed is reduced to worsen atomization, the spray form is changed due to axial displacement of the valve body, and the flow rate is varied due to variation in the lift, whereby combustion is likely to become worse. Accordingly, the lift amount L3 and the lift holding period Δt3 are set so that the fuel amount injected in the state of the lift amount L3 becomes so small that it can be ignored with respect to the entire injection amount.

By changing the lift amount of the fuel injector like this, the fuel velocity in the nozzle can be changed. FIG. 15 shows the change with time of the fuel velocity (U2 of FIG. 11) in the vicinity of the nozzle wall surface. When the valve opens at t=0, the fuel flows into the nozzle and the fuel velocity in the vicinity of the nozzle wall surface becomes U21. Since the lift amount is kept at L1 until Δt1, the fuel velocity is kept at U21. When the time passes t=Δt1, the fuel velocity in the vicinity of the nozzle wall surface abruptly increases, and reaches a maximum speed U22 at t=t_umax. When the lift amount becomes L3 at t=Δt1+Δt2, the injection amount becomes substantially zero. Therefore, the flow velocity decreases from t=t_umax to t=Δt1+Δt2, and becomes substantially zero at t=Δt1+Δt2.

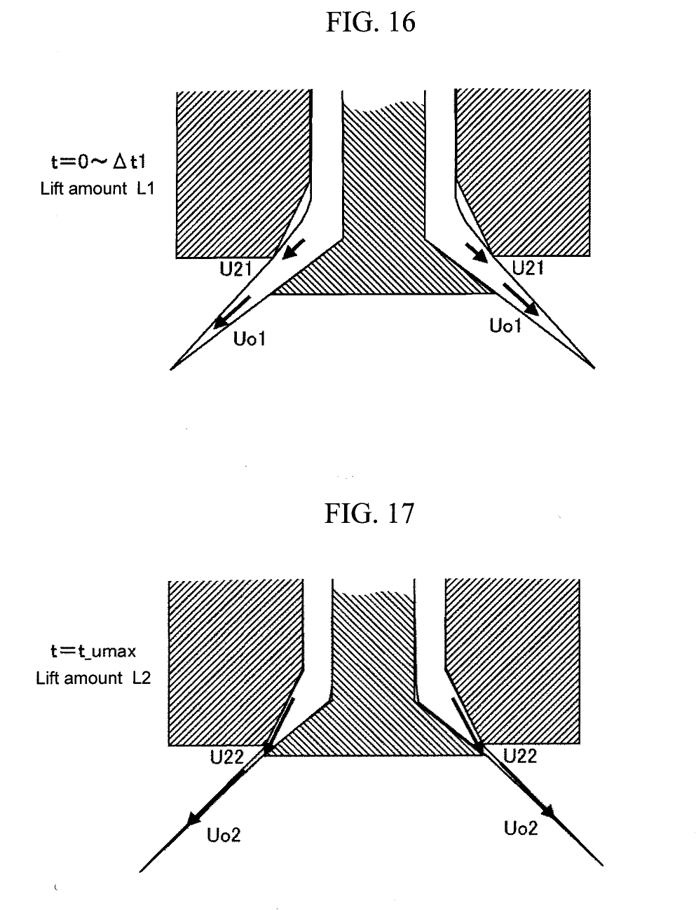

Next, the reason of increase in the fuel velocity at t=t_umax will be described with use of FIGS. 16 and 17. FIG. 16 shows the fuel flow in the nozzle at t=0 to Δt1 with the lift amount L1. FIG. 17 shows the fuel flow in the nozzle at t=t_umax with the lift amount L2. In order to atomize the liquid film efficiently, the velocity of the fuel injected from the injector needs to be sufficiently high. For example, a fuel injection speed Uo1 at the period of injection with the lift amount L1 is about 100 to 200 m/s. Therefore, a strong inertial force works on the fuel to be injected.

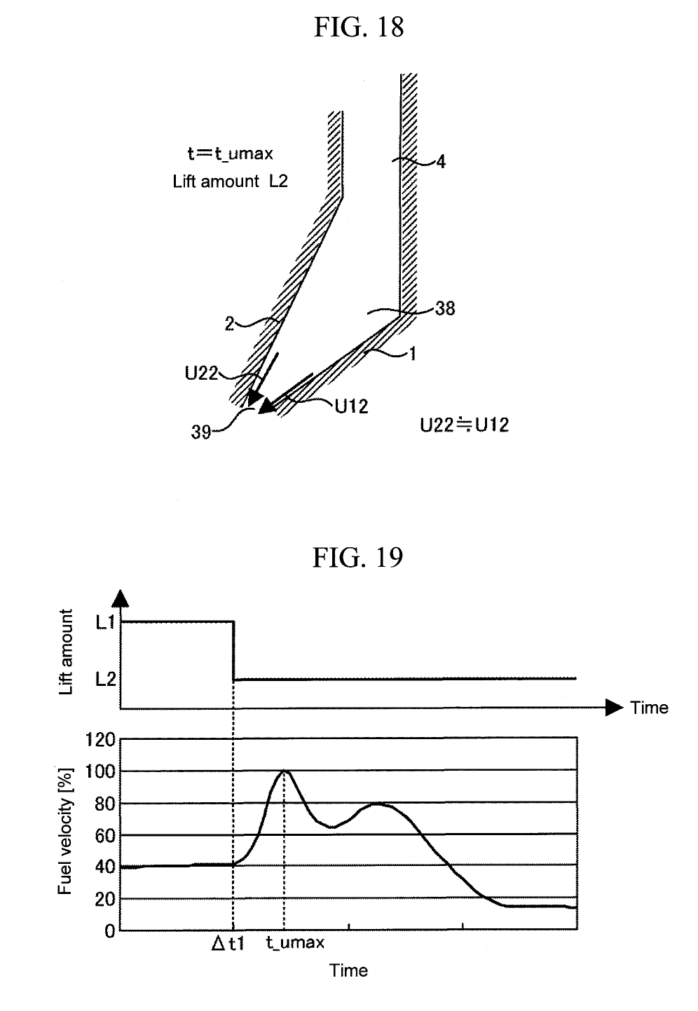

Even when the lift amount abruptly reduces from L1 to L2 at the time t=Δt1, the flow rate of the fuel does not immediately reduce due to the inertial force. Meanwhile, the opening area is decreased as a result that the lift amount is reduced to L2, and therefore, the injection speed (=flow rate/opening area) Uo2 becomes large as compared with Uo1 in the case of the lift amount L1. Further, the opening portion 39 is contracted by the reduction of the lift amount, and therefore, the velocity distribution in the injection port becomes uniform as shown in FIG. 18. More specifically, the fuel velocity U22 in the vicinity of the nozzle wall surface becomes substantially equivalent to the fuel velocity U12 in the vicinity of the valve body surface. By the action of the inertial force, decrease in the opening area and uniformization of the velocity distribution, the fuel velocity U22 in the vicinity of the nozzle wall surface significantly increases as compared with the case in which the lift is kept at L1.

FIG. 19 shows the change of the fuel velocity U2 in the vicinity of the nozzle wall surface in the case of changing the lift amount to L2 from L1. The present result is the result of calculation by using fluid numerical simulation (CFD). From FIG. 19, the state can be confirmed, in which immediately after the lift amount is reduced to L2 from L1, the fuel velocity abruptly increases, and thereafter, reduces.

As a result that the velocity in the vicinity of the nozzle wall surface increases, the carbon and the non-volatile impurities which adhere onto the nozzle wall surface are cleaned and removed by the shearing force of the fuel. The cleaning and removal are repeatedly performed at each fuel injection, and therefore, growth of the deposits on the nozzle wall surface can be prevented.

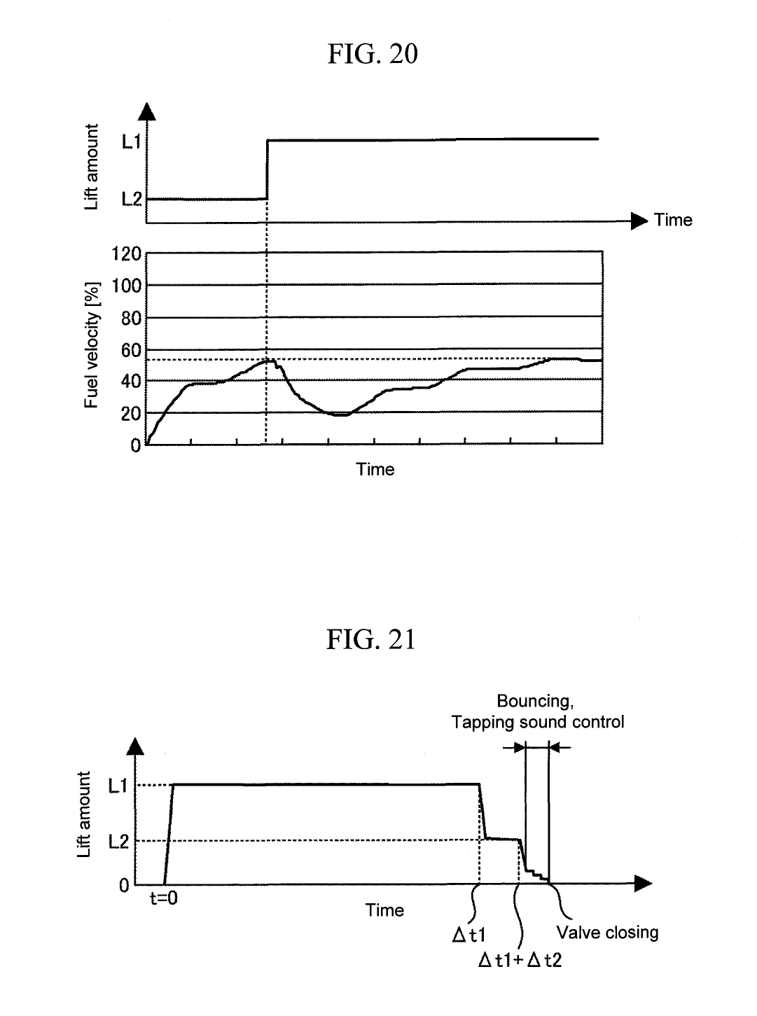

As described in the above, in order to increase the fuel flow velocity by reducing the lift amount, a sufficient inertial force needs to be act on the fuel before the lift is lowered. Accordingly, even if the lift amount is set to a small lift amount from the state where the fuel is stopped as in the initial stage of valve opening, the fuel velocity is not increased sufficiently. FIG. 20 shows the change of the fuel velocity when the valve is opened with the small lift amount L2 from the valve closing state, and after the state of L2 is kept for a while, the lift amount is set to the larger L1. The present result is also the result of calculation by using the fluid numerical simulation (CFD). It can be confirmed that the maximum flow velocity in the state with the small lift amount (L2) is equivalent to the fuel velocity in the state with the large lift amount (L1) and the velocity cannot be increased.

Similarly in the operation of lowering the lift to L3 in order to suppress bounding and tapping sound of the valve body, the fuel flow velocity immediately before the lift is lowered to L3 is reduced. Therefore, a sufficient inertial force does not work and the velocity of the fuel cannot be increased.

Therefore, in order to generate a fuel flow at a high velocity to prevent deposits effectively, it is necessary to make the state of keeping an intermediate lift amount between the state with a sufficient amount of fuel injected with a high lift amount (main injection state) and the low lift state at an extremely low flow rate to suppress bouncing and tapping sound of the valve body.

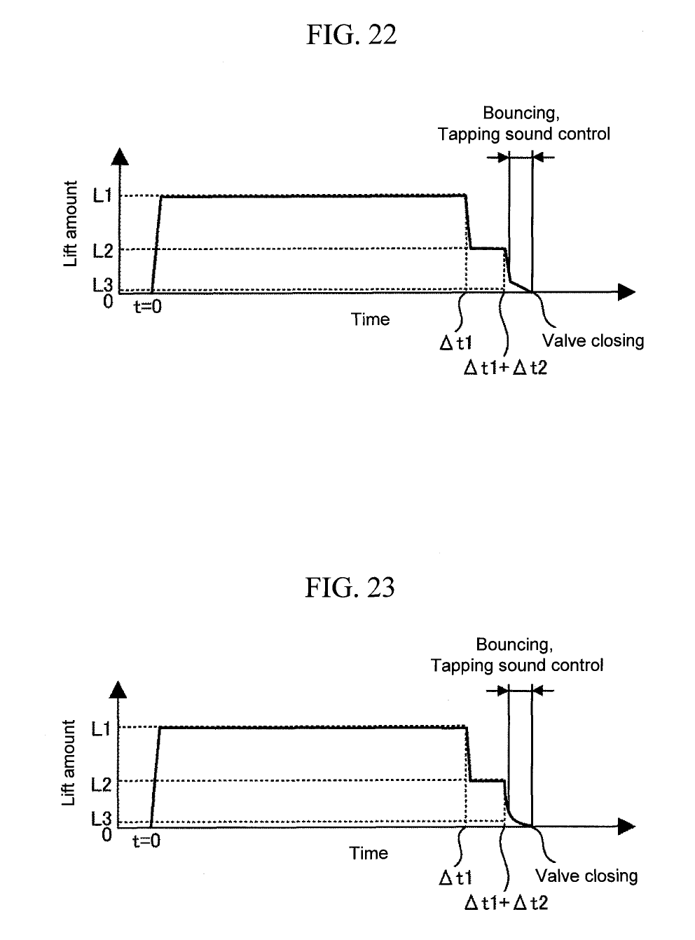

The valve control for suppressing bouncing and tapping sound of the valve body may be performed by the method which lowers the lift stepwise as shown in FIG. 21, for example. Further, the valve control for suppressing bounding and tapping sound of the valve body may be performed by the method which continuously lowers the lift as shown in FIGS. 22 and 23, for example. The lift amount, the lift profile and the control period are set so that the fuel amount which is injected in the valve control period for suppressing the bouncing and tapping sound of the valve body becomes very small (generally 0.1% or less) with respect to the entire injection amount (the injection amount from valve opening to valve closing).

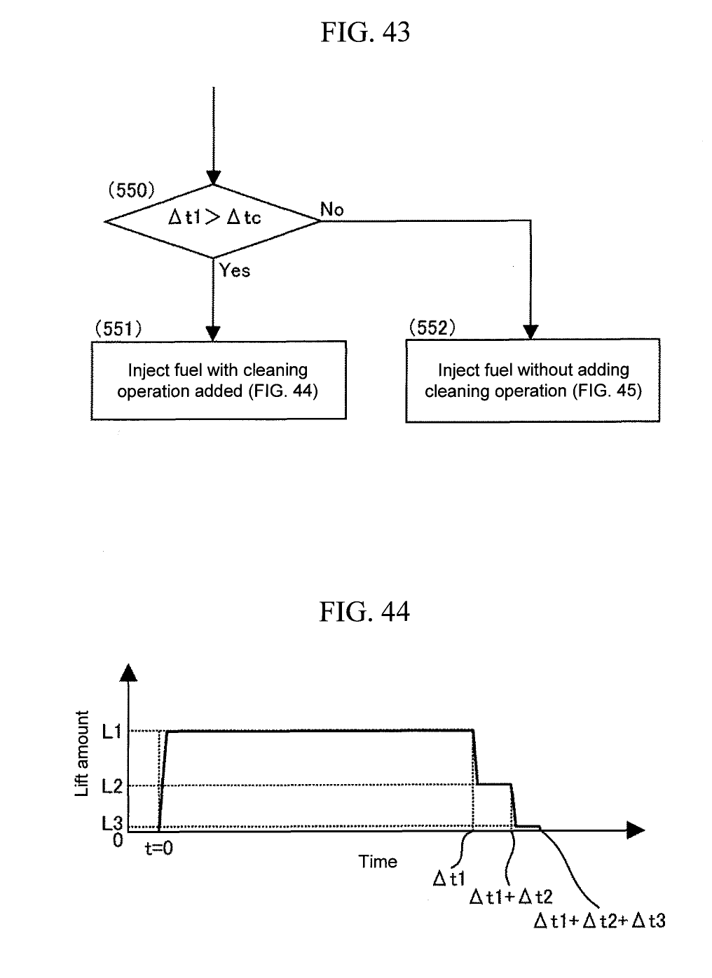

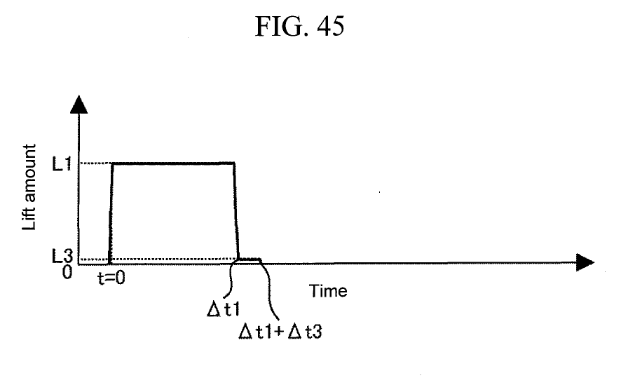

Further, the control for cleaning by holding the lift amount of the valve body at L2 as shown in the flow of FIG. 13 may be prohibited according to the period Δt1 of the main fuel injection (injection with the lift L1). More specifically, as shown in FIG. 43, when the period Δt1 of the main injection is larger than a predetermined threshold value Δtc according to processing 550, fuel injection with the addition of the nozzle cleaning operation (fuel injection by the lift L2) is carried out (FIG. 44). Meanwhile, when the period Δt1 of the main fuel injection is smaller than the predetermined threshold value Δtc according to processing 550, fuel injection is carried out without adding the nozzle cleaning operation (fuel injection by the lift L2) (FIG. 45).

In divided injection or the like in which the fuel is dividedly injected a plurality of periods in one cycle, the injection period sometimes has a large influence on the combustion performance. In this case, if the cleaning operation by the lift amount L2 is added, the injection period becomes long and the combustion is likely to be worsened. Such a problem can be solved by switching whether or not the cleaning operation is added in accordance with the main injection period Δt1.

Next, a second embodiment in the present invention will be described.

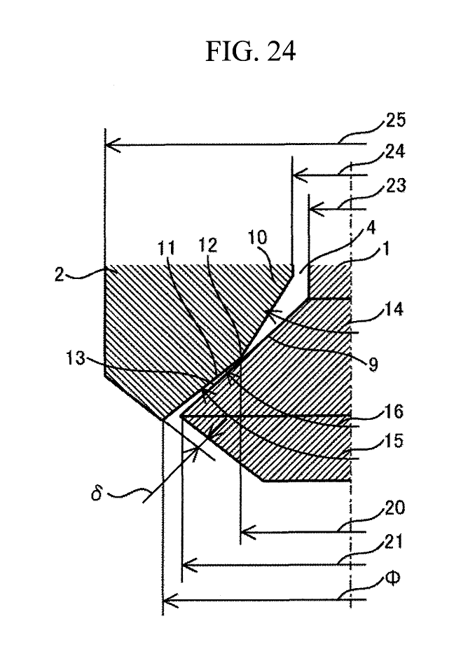

A basic structure of a fuel injector of the second embodiment in the present invention is similar to that of the fuel injector of the first embodiment, but differs in only the structure of the injection hole. A structure of the injection hole 3 of the fuel injector of the second embodiment will be described with use of FIG. 24. FIG. 24 is a sectional view showing an internal structure of the injection hole 3 at the valve closing time. In the injection hole 3, the nozzle 2 and the valve body 1 respectively have tapers each in the shape of a substantially conical surface. A taper angle 16 (angle formed by the taper surface and a taper surface at an opposite side from it) of a valve side taper surface 9 is, for example, 90°, a taper angle 14 of a nozzle upstream side taper surface 10 is, for example, 80°, and a taper angle 15 of a nozzle downstream side taper surface 11 is, for example, 100°. More specifically, the taper angle becomes larger in sequence of the nozzle upstream side taper surface 10, the valve body side taper surface 9 and the nozzle downstream side taper surface 11. At the valve closing time, the valve body 1 and the nozzle 2 are in contact with each other at the contraction portion 12, and a nozzle terminal end portion is projected by 6 with respect to a valve body terminal end portion. When the nozzle terminal end portion diameter is set as 4, the projected amount 6 is about 0.5% of φ, for example.

A fuel passes through the fuel channel 4 in the gap between the valve body 1 and the nozzle 2 and reaches the contraction portion 12, and in this case, the valve body 1 and the nozzle 2 are in contact with each other at the contraction portion 12. Therefore, the flow of the fuel is shut off in the contraction portion 12, and the fuel is not injected.

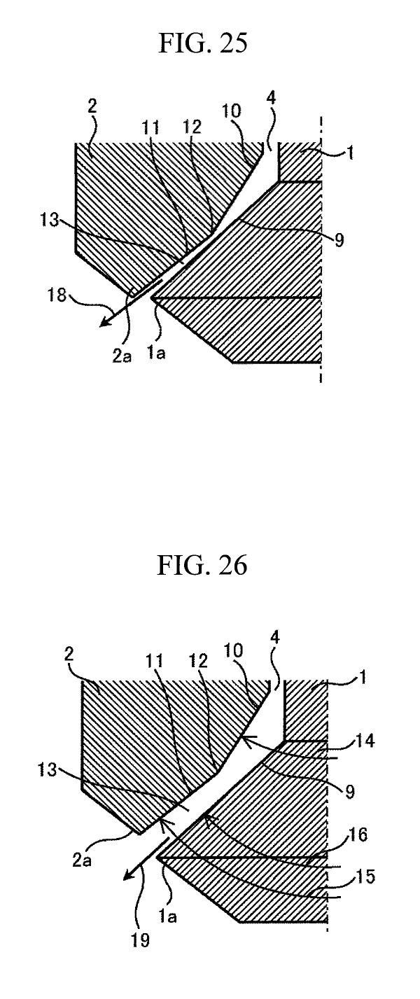

FIG. 25 is a sectional view showing an internal structure of the injection hole when the lift amount of the valve body is small. When the lift amount of the valve body is small, the fuel which passes through the fuel channel 4 in the gap between the valve body 1 and the nozzle 2 passes through a channel enlarged portion 13 configured by the contraction portion 12, the nozzle side taper surface 11 and the valve body side taper surface 9, and is injected outside the fuel injection device. A fuel injection device is generally in a substantially cylindrical shape, and therefore, in the vicinity of the valve body where the fuel channel extends to the outside diameter side, the channel sectional area is enlarged in the horizontal direction. In the channel enlarged portion 13 according to the present embodiment, the channel section in the section including the axial direction is enlarged toward the fuel channel downstream side. More specifically, in the present embodiment, the channel is enlarged not only in the horizontal direction but also in the vertical direction. At this time, the enlarged angle of the channel of the channel enlarged portion 13 is about 5° and small, and therefore, the flow of the fuel expands to all over the channel surface and goes to the injection hole. When the lift amount of the valve body 1 is small (including the case in which the valve body 1 is in contact with the nozzle 2) in the present embodiment, the nozzle terminal end portion is projected in the direction of injection from the valve body terminal end portion in the injection hole, and at the tip end portion of the injection hole, the channel wall at the valve body side does not exist. In other words, toward the direction of the flow of the fuel (ridge line direction of the taper surface 11 at the nozzle downstream side), the terminal end portion 2a of the nozzle 2 is projected in the ridge line direction of the valve body side taper surface of the valve body, with respect to the terminal end portion 1a of the valve body 1. As generally known as the Coanda effect, the liquid has the property of flowing along the wall surface when the wall surface exists in the vicinity of the liquid to be injected. In the state shown in FIG. 25, due to the Coanda effect, the flow is leaned to the nozzle side taper surface 11 at the injection hole tip end portion, and the fuel to be injected becomes a flow 18 along the nozzle side taper portion to be injected.

FIG. 26 is a sectional view of the internal structure of the injection hole when the lift amount of the valve body is large.

When the lift amount of the valve body is large, the fuel which passes through the fuel channel 4 in the gap between the valve body 1 and the nozzle 2 passes through the channel enlarged portion 13 which is configured by the contraction portion 12, the nozzle side taper surface 11 and the valve body side taper surface 9, and is injected outside the fuel injector. At this time, the flow rate is high, that is, the flow is fast, and the angle changes at the contraction portion 12. Therefore, in the channel enlarged portion 13, separation of the fluid occurs on the nozzle side taper surface 11. As a result, the flow of the fuel is leaned to the valve body side taper surface 9, and therefore, the fuel to be injected becomes a flow 19 along the valve body side taper surface 9 to be injected.

At this time, the valve body terminal end portion 1a is desirably projected in the direction of injection (or the ridge line direction of the valve body taper surface 9) more than the nozzle terminal end portion 2a in causing the injection of the fuel to be along the valve body taper surface 9, but the valve body terminal and portion 1a may not be projected, without being limited to this. This is because the space between the valve body 1 and the nozzle 11 is large as compared with the case of the small lift amount, and therefore, the flow along the taper surface 9 of the valve body 1 is hardly influenced by the taper surface 11 of the nozzle 2.

Thereby, when the lift amount of the valve body is small, the spray angle becomes that along the nozzle taper surface, whereas when the lift amount of the valve body is large, the spray angle becomes that along the valve body taper surface, and therefore, the spray angle can be controlled by controlling the lift amount of the valve body.

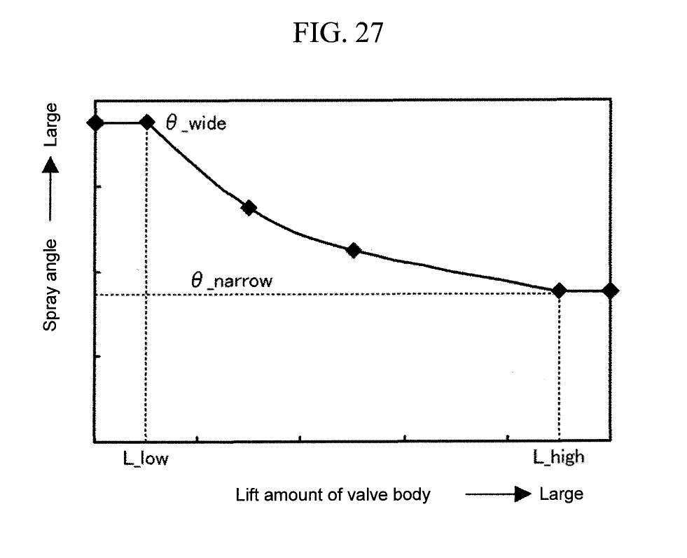

FIG. 27 shows the relationship between the lift amount of the valve body and the spray angle of the fuel injector configured by the above described structure. It can be understood that as the lift amount of the valve body 1 becomes larger, the spray angle is gradually changing to be small. From the result, the spray angle becomes smaller continuously as the lift amount of the valve body is increased, and the spray angle can be controlled by controlling the lift amount of the valve body.

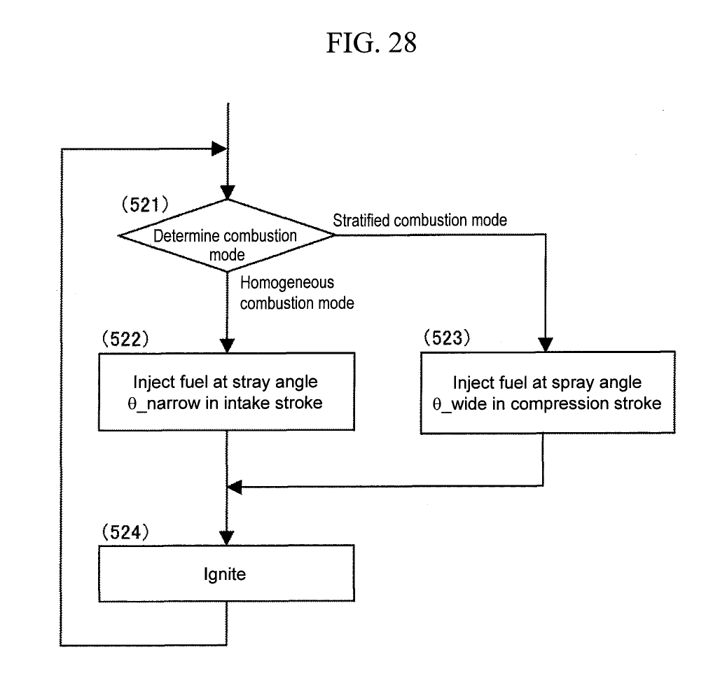

FIG. 28 shows the procedure of engine control which is carried out in the engine control unit (ECU).

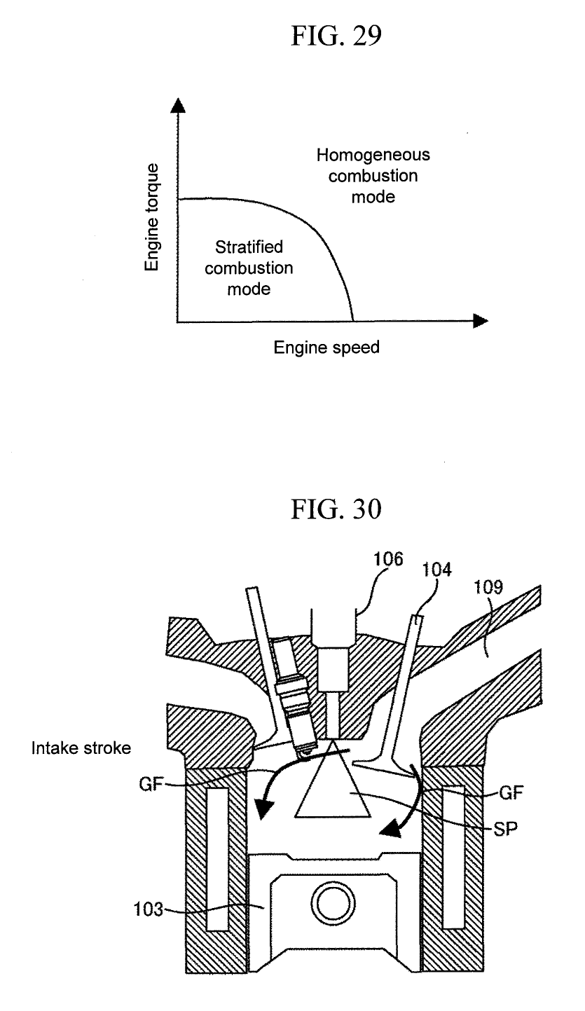

In processing 521, the combustion mode is determined from the required torque to the engine and the engine speed. The required torque of the engine is generally obtained from the information of the accelerator pedal opening degree, the change gear position, the vehicle speed, the oil water temperature and the like. As shown in FIG. 29, the combustion mode is assigned to the map of the engine speed and the torque, and whether to adopt the homogeneous combustion or stratified combustion is determined from the required torque and the engine speed in accordance with the map.

When it is determined as the homogeneous combustion mode in processing 521, the fuel is injected in the intake stroke at a spray angle θ_narrow (processing 522). In more concrete, in the fuel injector of the present embodiment, when the lift amount of the injector is large, the spray angle becomes small as shown in FIG. 27. Thus, the fuel is injected with a lift amount L_high with which the spray angle becomes θ_narrow which is the narrowest. As for the fuel injection amount at this time, the injection period of the fuel is determined so that the air fuel ratio in the cylinder substantially becomes the theoretical air fuel ratio (A/F=14.7).

Meanwhile, when it is determined as the stratified combustion mode in processing 521, the fuel is injected in the compression stroke at a spray angle θ_wide (processing 523). In more concrete, in the fuel injector of the present embodiment, when the lift amount of the injector is small, the spray angle becomes wide as shown in FIG. 27. Thus, the fuel is injected with the lift amount L_low with which the spray angle is θ_wide which is the widest. As for the fuel injection amount at this time, the injection period of the fuel is determined so that the air fuel ratio in the cylinder becomes larger than the theoretical air fuel ratio (for example, A/F=50). The set air fuel ratio at this time is determined in advance in accordance with the required load and the speed of the engine and the like.

As above, in the homogeneous combustion mode, spray at the narrow spray angle is injected in the intake stroke by making the lift amount of the injector large, whereas in the stratified combustion mode, spray at a wide spray angle is injected in the compression stroke by making the lift amount of the injector small.

The reason why the fuel is injected in the intake stroke in the homogeneous combustion mode is to mix the fuel and air sufficiently. The form of the spray and the gas flow at this time are shown in FIG. 30. Since the stroke is the intake stroke, the intake valve 104 is opened, and a strong gas flow GF occurs from the intake port 109 into the cylinder. When the spray collides with the wall surface, a wall flow is generated, and vaporization of the fuel and mixing with air are worsened. This leads to worsening of exhaust of the engine and reduction in fuel efficiency. In the present embodiment, the spray angle of the spray SP is made narrow in the homogeneous combustion mode, and thereby, collision and adherence of the spray with and to the intake valve 104 and the cylinder wall can be prevented.

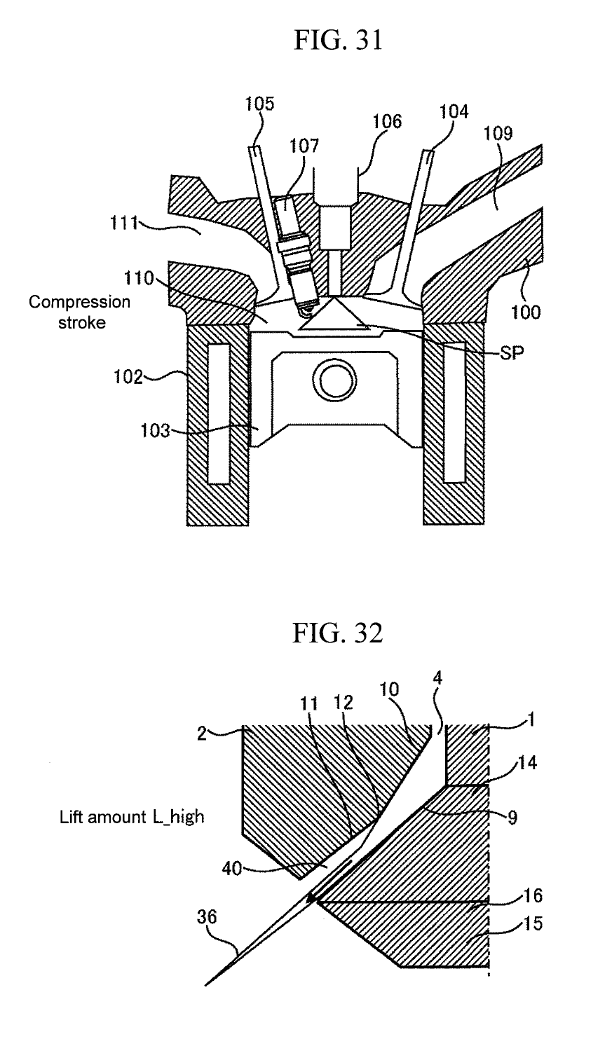

Meanwhile, the reason why the fuel is injected in the compression stroke in the stratified combustion mode is to make the fuel concentration in the vicinity of the ignition plug high with respect to the periphery of it. The spray form at this time is shown in FIG. 31. Since the stroke is the compression stroke, the intake valve 104 is closed and the gas flow in the cylinder is weak as compared with the intake stroke. The piston rises to the vicinity of the upper dead center. In the present embodiment, by making the spray angle of the spray SP large in the stratified combustion mode, the fuel can be gathered in the vicinity of the electrodes of the ignition plug 107. Thereby, the mixture gas which is lean as a whole can be stably ignited and combusted. Further, since the spray angle is large, the penetration force in the vertical direction (cylinder axis direction) of the spray becomes weak, and the spray can be prevented from colliding with and adhering to the piston. Thereby, worsening of exhaust of the engine and reduction in fuel efficiency can be prevented.

FIG. 32 shows an injector nozzle section at the period of the lift amount L_high. When fuel injection is performed in the state of a high lift amount, the fuel is separated from the surface of the taper surface 11 of the nozzle and a clearance 40 is formed in the fuel channel. This is because the taper surface of the nozzle changes by an angle at the contraction portion 12, and the taper surface 11 at the downstream side is widened. The fuel is to flow along the angle of the taper surface 10 by the inertial force of the fuel, and therefore, separation occurs on the taper surface 11. Especially in the state of the high lift of the valve body, the space between the valve body 1 and the taper surface 11 is large, and therefore, separation easily occurs.

The flow of the fuel does not exist on the surface of the taper surface 11, and therefore, even if the carbon and the like which occurs in combustion adhere to the surface, they are not washed away by the flow of the fuel. Further, the taper surface 11 is hardly cooled by the fuel, and therefore, it receives heat from the combustion gas at a high temperature and easily becomes high in temperature.

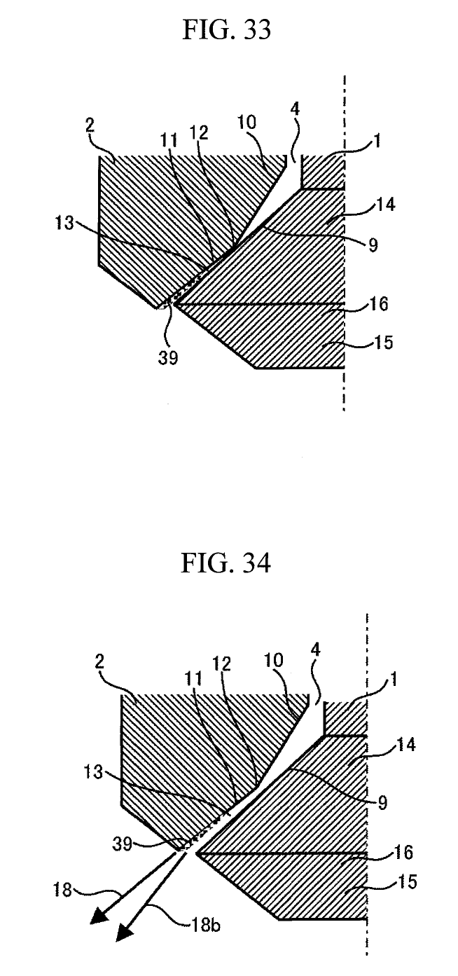

For example, if the state continues, in which the required load of the engine is high, and the homogeneous combustion mode in which the lift amount of the injector is high continues for a long time, the opening portion 39 occurs to the taper surface 11 as shown in FIG. 33 since the action of washing away by the fuel does not exist and the temperature is high.

If the opening portion 39 occurs to the taper surface 11, a predetermined spray angle cannot be obtained even if the lift amount of the valve body 1 is set to be low in order to inject spray at a wide angle in the stratified operation mode. When a deposit does not exist as shown in FIG. 34, the fuel flow 18 is originally obtained when the valve body is set to the low lift amount, but if the opening portion 39 occurs to the taper surface 11, the flow cannot be along the taper surface 11, and therefore, a fuel flow 18b is injected inward as compared with the original fuel flow 18. More specifically, the spray angle becomes narrower than the predetermined angle due to occurrence of the opening portion 39 to the taper surface 11, ignitability to the mixture gas becomes worse and exhaust becomes worse in the stratified combustion mode.

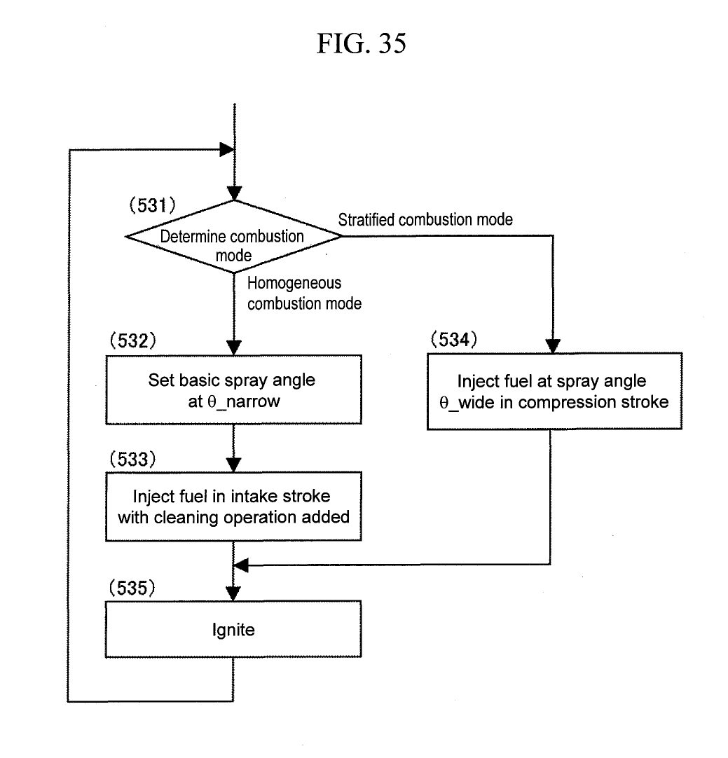

Thus, in the second embodiment according to the present invention, the fuel injection control which will be described as follows is performed. FIG. 35 shows the processing flow in the ECU at the time of fuel injection in the second embodiment according to the present invention.

In processing 531, from the required torque to the engine and the engine speed, the combustion mode is determined. The required torque of the engine is generally obtained from the information of the accelerator pedal opening degree, the change gear position, the vehicle speed, the oil water temperature and the like. As shown in FIG. 29, the combustion mode is assigned to the map of the engine speed and torque, and whether to adopt the homogeneous combustion or stratified combustion is determined from the required torque and the engine speed in accordance with the map.

When it is determined as the stratified combustion mode in processing 531, the fuel is injected in the compression stroke at the spray angle θ_wide (processing 533). In more concrete, in the fuel injector of the present embodiment, when the lift amount of the injector is small, the spray angle becomes wide as shown in FIG. 27. Thus, the fuel is injected with the lift amount L_low with which the spray angle is θ_wide which is the widest. As for the fuel injection amount at this time, the injection period of the fuel is determined so that the air fuel ratio in the cylinder becomes larger than the theoretical air fuel ratio (for example, A/F=50). The set air fuel ratio at this time is determined in advance in accordance with the required load and the speed of the engine and the like.

Meanwhile, when it is determined as the homogeneous combustion mode in processing 531, the basic spray angle is set at θ_narrow in processing 532. In more concrete, in the fuel injector of the present embodiment, when the lift amount of the injector is large, the spray angle becomes small as shown in FIG. 27. Thus, the lift amount with which the spray angle becomes θ_narrow which is the narrowest is set to the basic lift amount. Next, in processing 533, a cleaning operation which will be described later is added, and the fuel is injected in the intake stroke. As for the fuel injection amount at this time, the injection period of the fuel is determined so that the air fuel ratio in the cylinder substantially becomes the theoretical air fuel ratio (A/F=14.7).

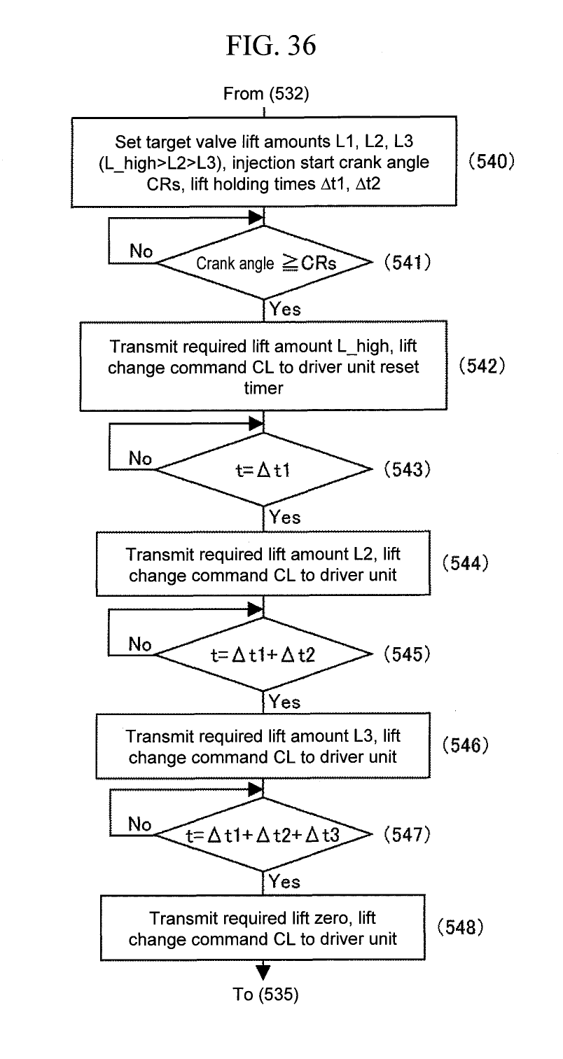

Next, with use of FIG. 36, processing 533 will be described in detail. FIG. 36 shows a processing flow in the ECU in processing 533.

In processing 540, the target lift amounts L1, L2 and L3 of the fuel injector, the holding periods Δt1, Δt2 and Δt3 of the respective lift amounts, and the injection start crank angle CRs are set. Here, L1 is the lift amount when the spray angle becomes θ_narrow, and is obtained from the relationship of the lift amount and the spray angle shown in FIG. 27 (L1=L_high).

Further, L2 is the lift amount when the spray angle becomes θ_wide, and is obtained from the relationship of the lift amount and the spray angle shown in FIG. 27 similarly to L1 (L2=L_low). Further, the lift amount L3 is set at a very small value so that the unit time injection amount when the lift amount is kept at L3 becomes about 1/100 or less with respect to the injection amount per unit time when the lift amount is set at L1, for example.

Δt1, Δt2 and Δt3 and CRs are set to obtain a proper air-fuel ratio and injection timing which are set in advance, based on various kinds of information such as the accelerator opening degree, the engine speed, the vehicle speed, the gear position, the oil water temperature and the fuel pressure which are input in the ECU.

The holding period Δt2 of the lift amount L2 is preferably shorter than the holding period Δt1 of the lift amount L1. Further, the holding period Δt2 may be fixed to a short period (for example, 0.3 ms) in advance.

Further, Δt3 is set at a short period, that is, about 1/10 or less of Δt1, for example, about 0.2 ms. More specifically, a fuel amount Mf1 which is injected in Δt3 with the lift amount L3 is about 1/1000 or less and very small with respect to the fuel amount Mf1 which is injected in Δt1 with the lift amount L1, and the fuel injection amount in Δt3 can be substantially ignored with respect to combustion.

For example, the required injection amount Mf is obtained from the intake air amount so that the air fuel ratio in the cylinder becomes the theoretical air fuel ratio (A/F=14.7). The required lift amounts L1 and L2 and the lift holding periods Δt1 and Δt2 are determined so that Mf1+Mf2 which is the total of the fuel amount Mf1 which is injected in Δt1 with the lift amount L1 and the fuel amount Mf2 which is injected in Δt2 with the lift amount L2 becomes the required injection amount Mf. Further, the injection start crank angle CRs is set at, for example, 90° after the intake upper dead center so that the fuel injection is performed within the intake stroke.

In processing 541, the injector waits until the present crank angle reaches the injection start crank angle CRs.

When the crank angle reaches the injection start crank angle CRs, in processing 542, the required lift amount L1 and the lift change command CL are transmitted to the driver unit, and the timer is reset (t=0). Thereby, the timer shows the elapsed time from the injection start.

In processing 543, an elapsed time (elapsed period) t and the lift holding period Δt1 are compared, and when the elapsed time becomes Δt1, the flow proceeds to processing 544.

In processing 544, the required lift amount L2 and the change command CL are transmitted to the driver unit.

In processing 545, the elapsed time t and the lift holding period Δt1+Δt2 are compared, and when the elapsed time reaches Δt1+Δt2, the flow proceeds to processing 546.

In processing 546, the required lift amount L3 and the lift change command CL are transmitted to the driver unit.

In processing 547, the elapsed time t and the lift holding period Δt1+Δt2+Δt3 are compared, and when the elapsed time reaches Δt1+Δt2+Δt3, the flow proceeds to processing 548.

In processing 548, the required lift amount L=0 and the lift change command CL are transmitted to the driver unit.

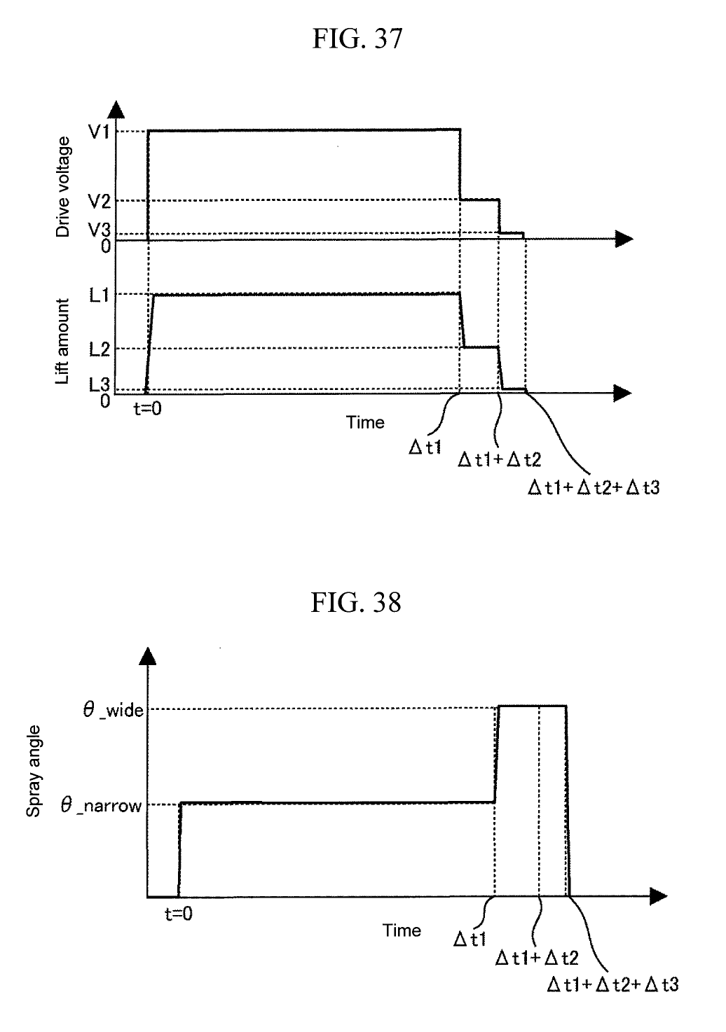

According to the processing flow at the fuel injection period shown above, the voltage applied to the fuel injector and the lift amount are as shown in FIG. 37.

According to the processing flow at the fuel injection period shown above, the angle of the spray injected from the fuel injector is as shown in FIG. 38.

More specifically, from t=0 to t=Δt1 in which the fuel is injected with the lift L1, the fuel is injected at the narrow spray angle θ_narrow, whereas from t=Δt1 until the time before valve closing in which the fuel is injected with the lift L2 and the lift L3, the fuel is injected at a wide spray angle θ_wide.

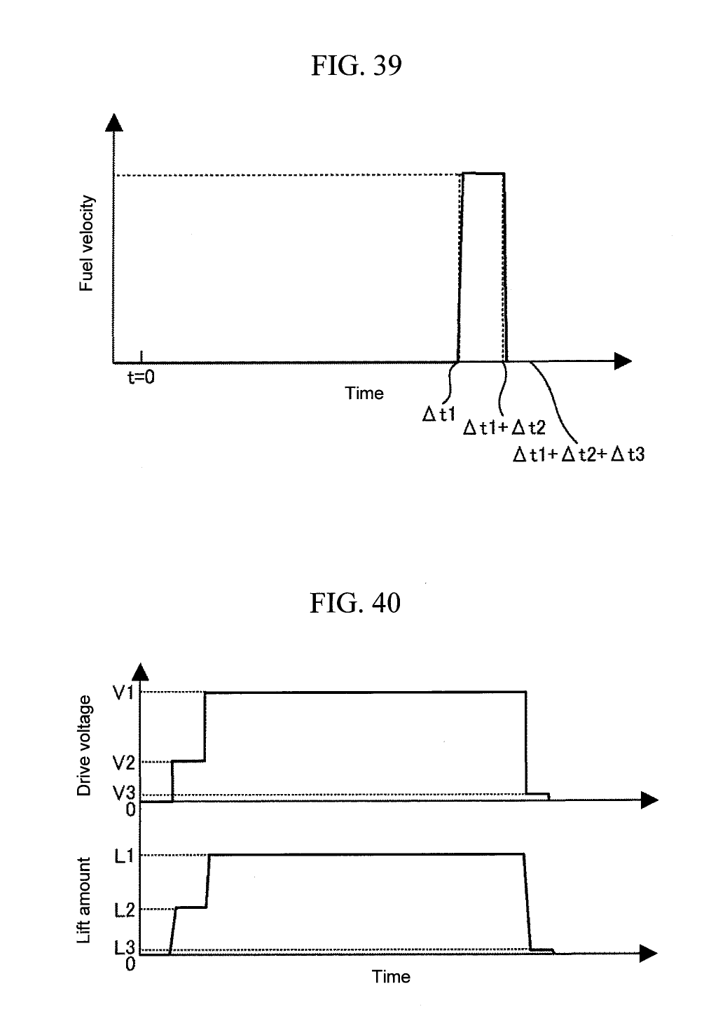

FIG. 39 shows a fuel velocity in the vicinity of the nozzle taper surface 12. FIG. 39 shows the fuel flow in the nozzle in the case of the lift amount L2. As shown in FIG. 32, when the lift amount is large (L1), the fuel flow separates on the nozzle taper surface 12, and therefore, the fuel velocity is zero. When the lift amount decreases to L2 at t=Δt1, the fuel flows along the nozzle taper surface 12 as shown in FIG. 25. Therefore, at t=Δt1 to Δt1+Δ2 and thereafter, the fuel velocity in the vicinity of the nozzle taper surface 12 abruptly increases. When the lift lowers to L3 at t=Δt1+Δt2, the fuel hardly flows, and therefore, the fuel velocity in the vicinity of the nozzle taper surface 12 becomes substantially zero.

In the period of t=Δt1 to Δt1+Δt2, the fuel velocity in the vicinity of the nozzle taper surface 12 increases, and therefore, the carbon and the non-volatile impurities adhering onto the nozzle taper surface by the fuel flow are cleaned and removed by the shearing force of the fuel. The cleaning and removal are repeatedly performed at each fuel injection, and therefore, deposit growth on the nozzle taper surface can be prevented.

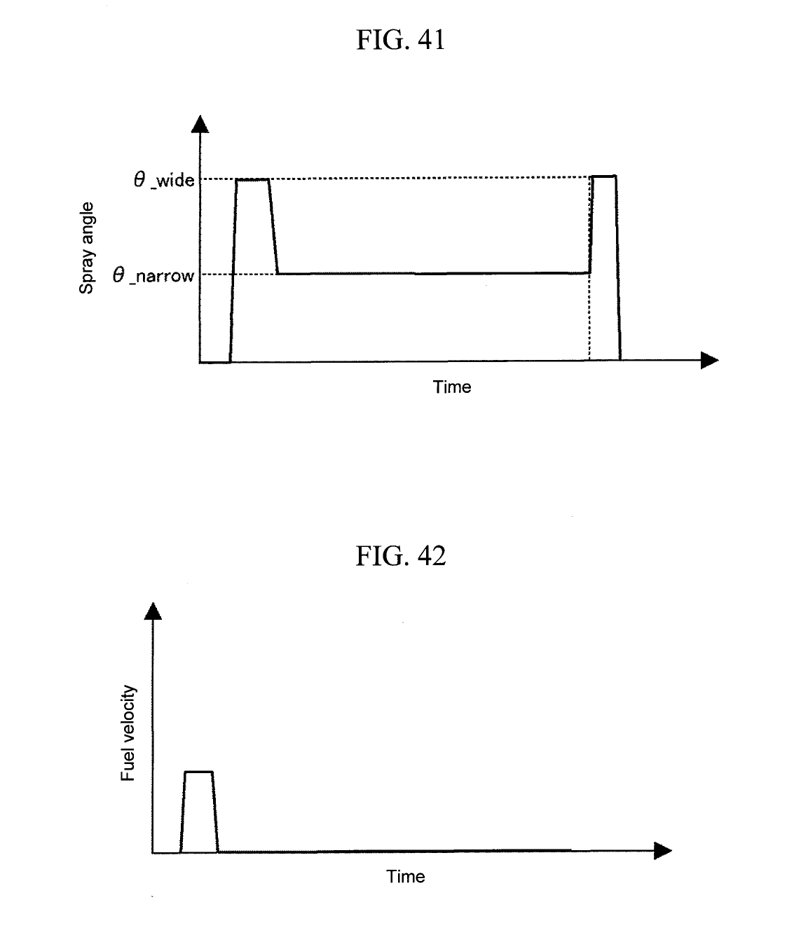

As shown in FIGS. 40 and 41, the spray angle may be made narrow after the spray angle immediately after injection state is made wide by performing injection with the lift amount L2 before injection with the lift amount L1. The fuel velocity in the vicinity of the nozzle taper surface in this case is high immediately after injection start, and thereafter, becomes substantially zero when the spray angle becomes narrow, as shown in FIG. 42. By the fuel flow in the vicinity of the nozzle taper surface immediately after the injection start, the carbons and non-volatile impurities adhering onto the nozzle taper surface are cleaned and removed.

When the valve body lift is lowered after the fuel is injected in the state of the high lift of the valve body, the fuel velocity increases by the inertial force which the fuel itself has, as described above. Therefore, the increase in the fuel velocity with the lift L2 is larger, and higher cleaning effect is obtained, by changing the spray angle to the wide spray angle from the narrow spray angle as shown in FIG. 37.

1. A control unit of a fuel injector capable of controlling a lift height that is a distance between a valve body and a valve seat,
wherein during a fuel injection period until the valve body is seated after the valve body separates from the valve seat, after the lift height is controlled to a first height, a period in which the lift height is controlled to a second height which is lower than the first height is provided for a predetermined period.

2. The control unit according to claim 1,
wherein the period in which the lift height is controlled to the second height is started from any timing in a latter half of a case of dividing the fuel injection period until the valve body is seated after separating from the valve seat into two.

3. The control unit according to claim 1,
wherein after the lift height is controlled to the second height, the valve body is seated on the valve seat.

4. The control unit according to claim 1,
wherein during the fuel injection period until the valve body is seated after separating from the valve seat, the lift height is controlled from the first height to the second height stepwise or continuously.

5. The control unit according to claim 3,
wherein after the valve body is held at the second height, the lift height of the valve body is continuously decreased.

6. A control unit of a fuel injector according claim 1,
wherein the fuel injector is an outward-opening type fuel injector which can set a spray angle in a case of a lift height of a valve body being low to be wider than a spray angle in a case of the lift height of the valve body being high.

7. A control unit of a fuel injector that controls a fuel injector capable of controlling a lift height that is a distance between a valve body and a valve seat,
wherein immediately after an injector drive signal for opening a valve by controlling the valve body is output, an injector drive signal for reducing the lift height in at least two steps is output.

8. A control unit of a fuel injector that controls a fuel injector capable of controlling a lift height that is a distance between a valve body and a valve seat,
wherein immediately after an injector drive signal for opening a valve at a valve body lift height by controlling the valve body is output, an injector drive signal for holding valve body lift which is lower than the valve body lift height is output, and thereafter, an injector drive signal for continuously decreasing the valve body lift height is output.

9. A control unit of a fuel injector according to claim 2,
wherein the fuel injector is an outward-opening type fuel injector which can set a spray angle in a case of a lift height of a valve body being low to be wider than a spray angle in a case of the lift height of the valve body being high.

10. A control unit of a fuel injector according to claim 3,
wherein the fuel injector is an outward-opening type fuel injector which can set a spray angle in a case of a lift height of a valve body being low to be wider than a spray angle in a case of the lift height of the valve body being high.

11. A control unit of a fuel injector according to claim 4,
wherein the fuel injector is an outward-opening type fuel injector which can set a spray angle in a case of a lift height of a valve body being low to be wider than a spray angle in a case of the lift height of the valve body being high.
